(19) United States
(12) Patent Application Publication
(10) Pub. No.: US 2022/0039335 A1
(43) Pub. Date: Feb. 10, 2022

(54) Adjustable Grow Tent Assembly with Reflective Symmetry

(71) Applicants: Thomas V. Lopez, Phoenix, AZ (US); Michelle L. Phillips, Phoenix, AZ (US)

(72) Inventors: Thomas V. Lopez, Phoenix, AZ (US); Michelle L. Phillips, Phoenix, AZ (US)

(21) Appl. No.: 16/989,856

(22) Filed: Aug. 10, 2020

(51) Int. Cl. A01G 13/02; E04H 15/46; E04H 15/54

(52) U.S. Cl. CPC A01G 13/0212; E04H 15/54; E04H 15/46; A01G 13/0225

(57) ABSTRACT

The present invention relates to the field of growing plants indoors, more particularly, relates to a unique grow tent assembly and apparatus that enables growth of plants indoors. Grow tents are portable enclosed structures that enables users to grow plants in indoors. Generally, grow tents are made of plastic or metal framing with a tent fabric made of canvas on the exterior and reflective material in the interior which increases the intensity of light produced by built grow lights through. reflection. However, major drawback of the conventional grow tents involves the subject to uneven light reflection produced by the grow lights effecting the growth of the plants grown in the grow tents. The present invention provides a unique structured grow tent built with at least six walls having hexagonal pattern on the interior reflective surface of the grow tent that improves the reflection of the light produced by the grow lights in the grow tent. Additionally, the disclosed invention provides an inbuilt as well as detachably attachable height extension system that allows users to extend the height of the grow tent.

### CROSS-REFERENCE TO RELATED APPLICATIONS

No related applications are previously filed.

### TECHNICAL FIELD OF THE INVENTION

The present invention relates to the field of growing plants indoors, more particularly, relates to a unique tent assembly and apparatus that enables growth of plants indoors.

### BACKGROUND OF THE INVENTION

Grow tents are portable enclosed structures that enables users to grow plants in indoors. Generally, grow tents are made of plastic or metal framing with a tent fabric made of canvas on the exterior and reflective material in the interior which increases the intensity of light produced by built grow lights through reflection. Different types of conventional grow tents are currently available in the marketplace. Mostly, the grow tents currently available in the marketplace are structured in squares or rectangle with only four walls and are provided in different sizes.

However, major drawback of the conventional grow tents involves the subject to uneven light reflection produced by the grow lights effecting the growth of the plants grown in the grow tents.

Most of the plants grown in the grow tents range in different sizes and specifically the plants that tend to grow taller requires additional roof space for better growth. However, the conventional grow tents are built with a roof which impacts the vertical plant growth when particular plants growth has reached the height of grow tent's roof. When these vertically growing plants are left in the grow tent, their growth is impacted due to less roof space. In this scenario, users may have to take those plants out of the grow tents and may have to leave them out. As the external environment conditions such as temperature. light, aeration etc. are different from the conditions maintained in the grow tent, growing the plants outside the grow tent will impact the growth of particular plants. Additionally, if the users intend to grow the plants in the same controlled conditions, they may have to invest in buying a new grow tent which is taller that the one they own.

There are a few inventions that have been enlisted in prior art based on the enhancement of grow tent light system. For example, a US Patent U.S. 10597896B1 issued to Nancy Hamilton and James Hamilton provides a unique grow tent lightening assembly for growing plants.

None of the prior art inventions and patents, taken either alone or in combination, is effective to overcome the identified defects of efficiently reflecting the light produced by the grow lights in the grow tents. Additionally, none of the prior art inventions and, taken either alone or in combination, is effective to overcome drawbacks of growing plants that tend to grow taller.

Hence, the present invention proposes to resolve the existent technical difficulties to eliminate the shortcomings of prior art. The present invention provides a unique structured grow tent built with at least six walls having hexagonal pattern on the interior reflective surface of the grow tent that improves the reflection of the light produced by the grow lights in the grow tent. Additionally, the disclosed invention provides an inbuilt as well as detachably attachable height extension system that allows users to extend the height of the grow tent.

### SUMMARY OF THE INVENTION

Embodiments of the invention solve the above-mentioned problems by providing a unique tent assembly also called as grow tent useful for growing plants indoor. The grow tent assembly comprises of a tent frame assembly and a tent fabric cover assembly which is used to cover the tent frame to form an enclosed grow tent structure. The tent frame assembly includes a primary frame base member and a secondary frame roof member both includes at least six vertices. The tent frame assembly further includes six primary and secondary elongated vertical pole means each containing upper and lower ends. The lower ends of the primary elongated vertical pole means are detachably attachable to the vertices of the primary frame base member. The upper ends of the secondary elongated vertical pole means are detachably attachable to the vertices of the secondary frame roof member. Finally, the lower ends of the secondary elongated vertical pole means are adjustably attachable to the upper ends of primary elongated vertical pole means.

Additionally, the tent fabric cover assembly which is used to cover the tent frame for an enclosed grow tent structure includes a central roof cover panel, a central base panel, at least six wall cover panels and at least one foldable height adjustment cover panel.

In accordance with one aspect of a preferred method of the present invention, a method of assembling grow tent is provided. The provided method comprising the steps of (1) placing the primary frame base member on the floor, (2) connecting the primary elongated vertical pole means to the vertices of the primary frame base member, (3) placing the secondary frame roof member on the floor, (4) connecting the secondary elongated vertical pole means to the vertices of the secondary frame roof member, (5) reversing the position of the frame roof member along with the connected secondary elongated vertical pole means, (6) connecting the lower ends of the secondary elongated vertical pole means to the upper ends of primary elongated vertical pole means in a way by inserting the lower ends of the secondary elongated vertical pole means to the upper ends of primary elongated vertical pole means, (7) locking the frame assembly using the levers available on the upper ends of primary elongated vertical pole means, (8) connecting the wall cover panels to each other and leaving at least two ends unconnected to form a single foldable cover panel, (9) placing the central base panel under the primary frame base member on the floor, (10) placing the central roof cover panel on the central roof cover panel and (11) enclosing the tent by connecting the upper ends of the single foldable wall cover panel to the edges of central roof cover panel and connecting the lower ends of single foldable wall cover panel to the edges of central base panel.

In accordance with another aspect of the present invention, a method of extending the height of grow tent is provided. The provided method comprising the steps of (1) opening the horizontal closable opening available on the single foldable wall cover panel forming a set of upper wall cover panel and lower wall cover panel, (2) unlocking the frame connection by lifting up levers available on the upper ends of the primary elongated vertical pole means; (3) extending the height of the tent frame assembly by lifting up the secondary elongated vertical pole means until desired height is achieved, (4) locking the connection and frame assembly by pulling down the levers available on the upper ends of the primary elongated vertical pole means; (5) enclosing the space obtained due to height extension by connecting the foldable height adjustment cover panel to the lower ends of the upper cover panel and (6) connecting the foldable height adjustment cover panel to the upper ends of the lower cover panel.

In accordance with yet another aspect of the present invention, a method of extending the height of grow tent is provided. The provided method may comprise steps of (1) opening the horizontal closable opening available on the single foldable wall cover panel further exposing a panel which is telescopically hidden inside the single foldable wall cover panel, (2) unlocking the frame connection by lifting up levers available on the upper ends of the primary elongated vertical pole means, (3) extending the height of the tent frame assembly by lifting up the secondary elongated vertical pole means until desired height is achieved and (4) locking the connection and frame assembly by pulling down the levers available on the upper ends of the primary elongated vertical pole means.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1A is a perspective view of grow tent frame with unextended roof.

FIG. 1B is a perspective view of grow tent frame with extended roof.

FIG. 2A provides an emphasized front perspective view pf height extending apparatus.

FIG. 2B provides an emphasized rear perspective view of height extending apparatus.

FIG. 3 is a perspective view of grow tent frame with a focused visualization of one of the vertical poles.

FIG. 4A is a front perspective visualization of grow tent with unextended roof.

FIG. 4B is a front perspective visualization of grow tent with extended roof.

FIG. 5 is a left side perspective visualization of grow tent with extended roof showing apertures.

FIG. 6 is a top plan detached view of grow tent visualizing six wall panels attached to the roof.

FIG. 7 a perspective sectional view of grow tent further visualizing hexagonal patterned reflective interior and a plant.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

The words “connected”, “attached”, “joined”, “mounted”, “fastened”, and the like should be interpreted to mean any manner of joining at least two objects including, but not limited to, the use of any fasteners such as screws, nuts and bolts, bolts, pin and clevis, one or more sections of hooks and corresponding one or more sections of loops, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

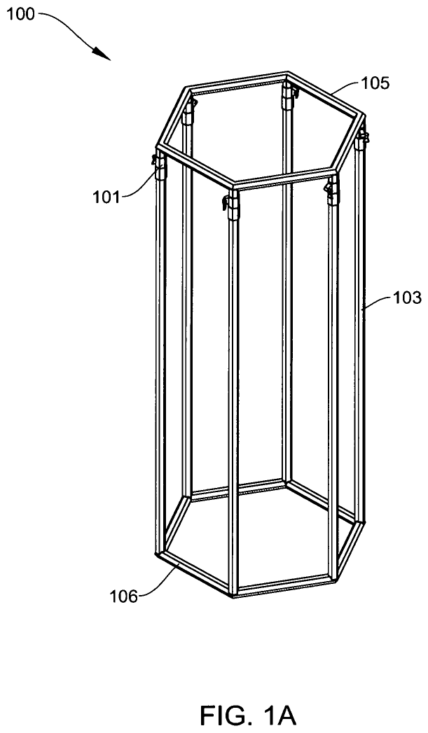

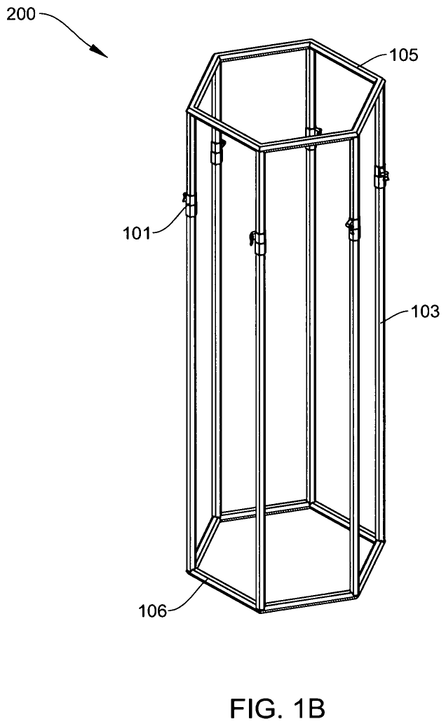

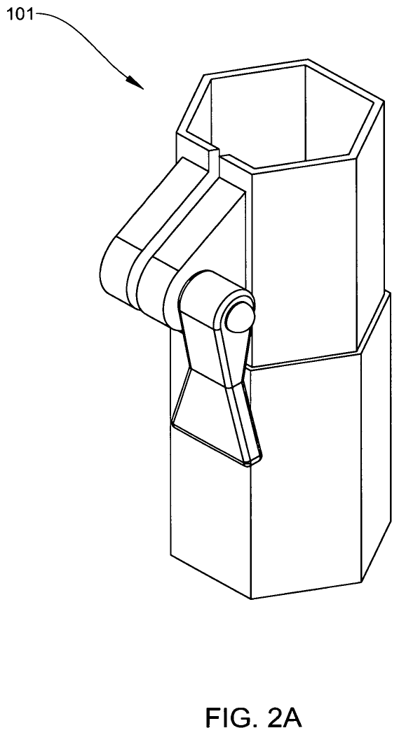

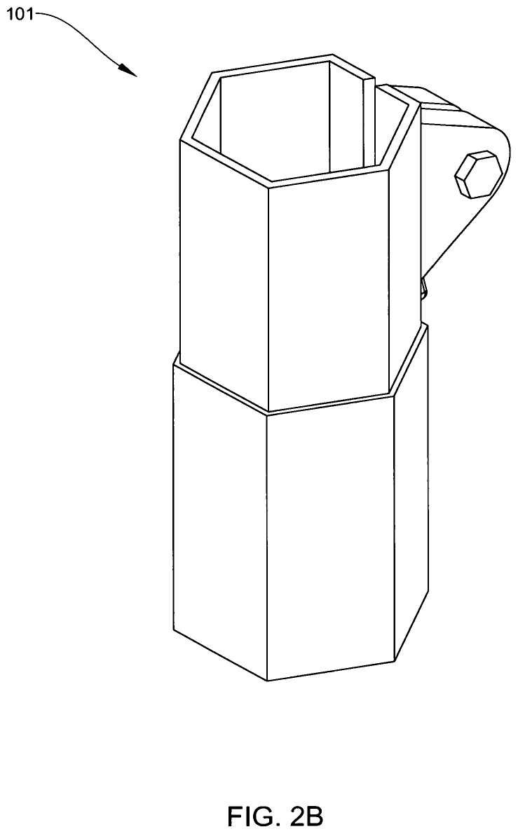

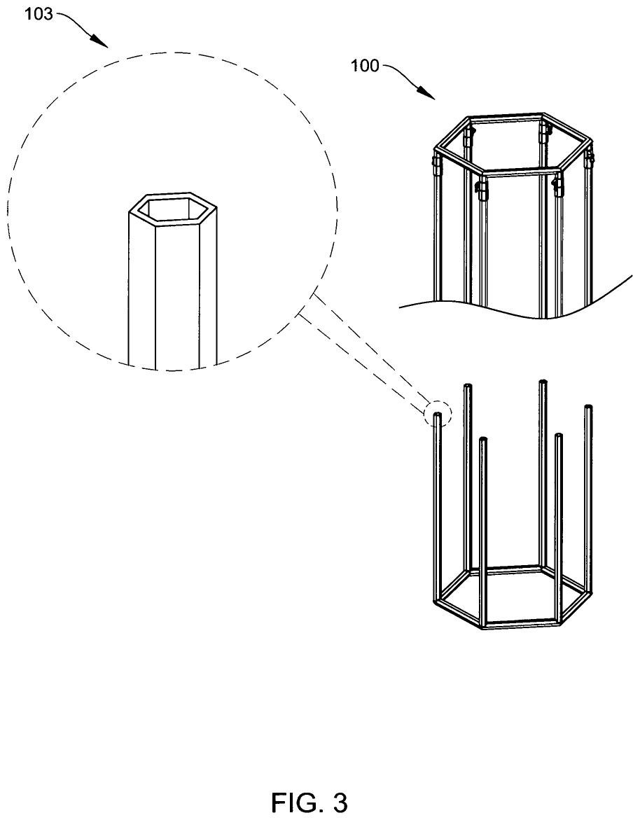

Turning to the figures and specifically FIG.1A, embodiments of the present invention comprise a grow tent frame assembly in an unextended state 100 further visualizing height adjustment means 101 attached to the upper ends of the six primary elongated vertical pole means 103 and lower ends of which are connected to the primary frame base member 106. Similarly, FIG. 1B provides visualization of a grow tent frame assembly in an extended state 200 further visualizing six secondary elongated vertical pole means 104 upper ends of which are attached to the secondary frame roof member 105. FIG. 1B further visualizes height adjustment means 101 attached to the upper ends of the six primary elongated vertical pole means 103. Similarly, FIG.2A and FIG. 2B provides an emphasized front and rear perspective view of height adjustment means 101 further visualizing the height adjustment lever. Additionally, FIG. 3 provides a perspective view of grow tent frame 100 in unextended state with a focused visualization of one of the six elongated vertical pole means 103 further visualizing the space available inside the elongated vertical pole means that allows the frame assembly to telescopically adjust the frame height according to the users requirements.

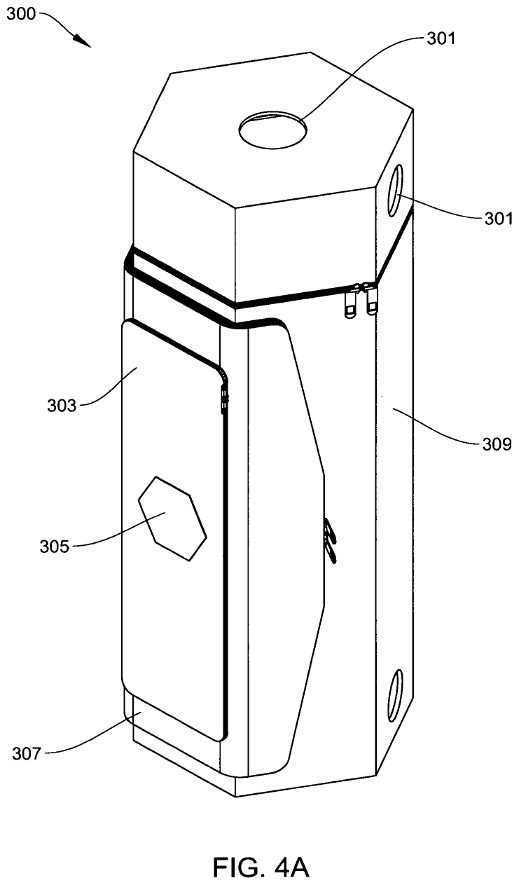

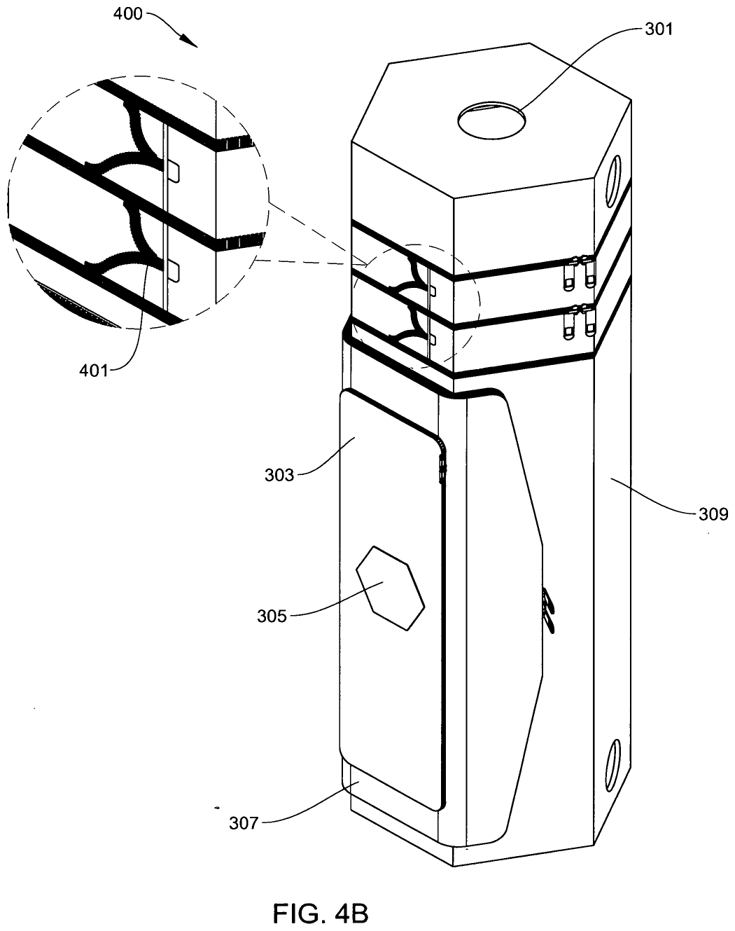

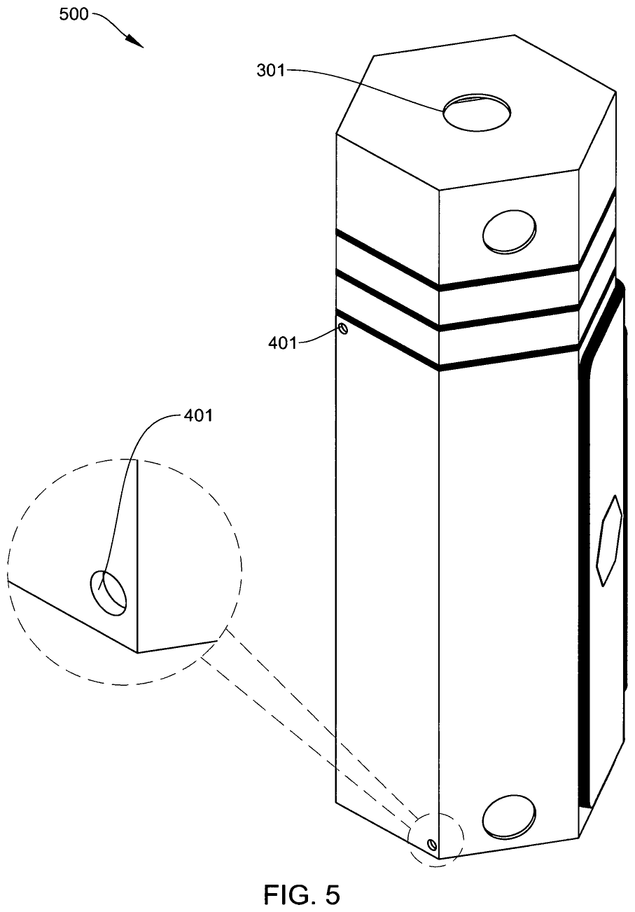

Now referring to FIG. 4A that provides a front perspective visualization of grow tent with unextended roof 300, wherein further visualizing the grow tent fabric cover assembly attached to the grow tent frame assembly. FIG. 4A further visualizes a central roof cover panel, wherein the said central roof cover panel includes a circular opening 301, three of the six cover panels 309 further visualizing plurality of circular openings 301. The front panel 307 of the grow tent fabric cover assembly further a front closable opening 303 which acts as a door to enter the grow tent and window 305 to check the progress of plant growth from outside of the grow tent. Similarly, FIG. 4B provides a front perspective visualization of grow tent with extended roof 400 wherein further visualizing the grow tent fabric cover assembly attached to the grow tent frame assembly. FIG. 4A further visualizes a detachably attachable horizontal closable opening 401 that further includes a telescopically hidden panel which is extended exteriorly and enables users to vertically extend the height of the said tent assembly. Similarly, FIG. 5 visualizes a left side perspective visualization of grow tent 500 with extended roof showing apertures 401 diagonally arranges at the two corners of one of the six cover panels.

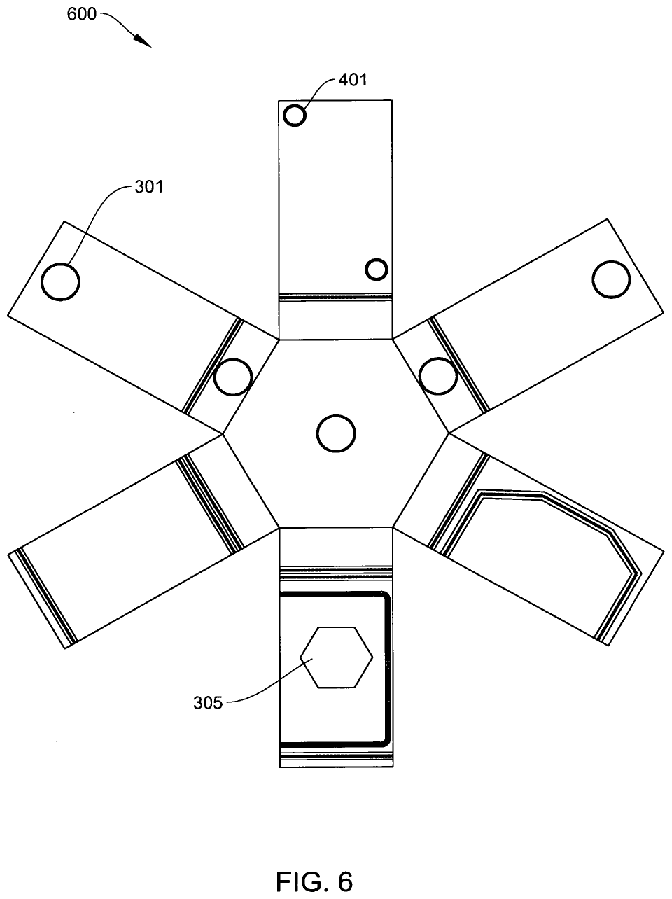

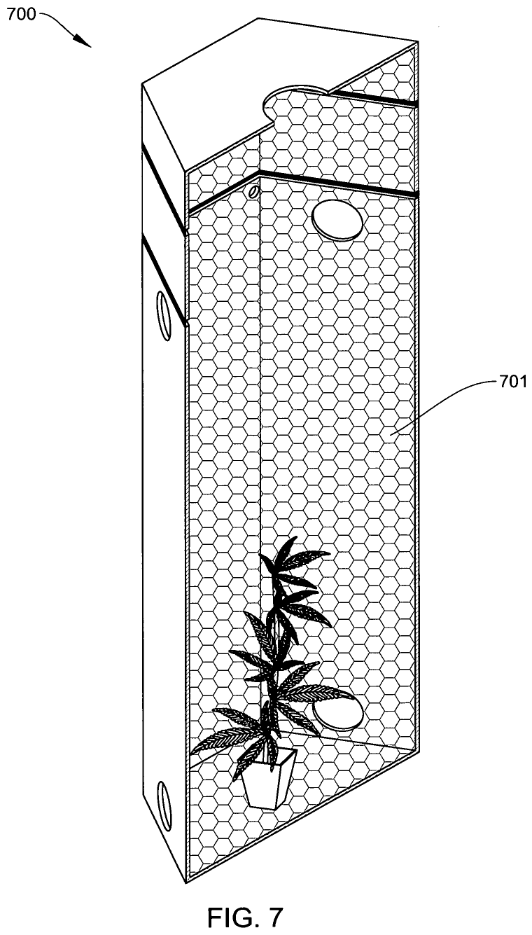

Referring to FIG. 6, the grow tent fabric cover assembly 600 includes at least six wall cover panels that are detachably attachable to each other, detachably attachable to the said central roof cover panel, and to the said central base panel, wherein the said six wall cover panels further includes a detachably attachable horizontal closable opening, wherein the said six wall cover panels includes a front panel, a back panel, a front right side panel, a back right side panel, a front left side panel and a back left side panel, wherein the said front panel further includes a window and a detachably attachable closable opening which acts as a door to enter into the grow tent, wherein the said back right side panel and the back left side panel further includes an upper and lower vents, wherein the said back panel further includes at least two apertures which are diagonally provided at the upper and lower corners of the said back panel. As shown in FIG. 7, the interior surface of the walls, roof and base of the grow tent 700 are provided with a reflective material further provided in a hexagonal pattern 701 for better reflection of light to the plants.

In one embodiment of the present invention, the grow tent assembly includes at least one foldable height adjustment cover panel, wherein the said foldable height adjustment cover panel further includes attachment means that enables detachable attachment of the said foldable height adjustment cover panel to the horizontal closable opening of the said six wall cover panels and enables users to vertically extend the height of the said tent assembly.

In another embodiment, the present invention relates to a method of assembling grow tent, the method comprising the steps of (1) placing the primary frame base member on the floor, (2) connecting the primary elongated vertical pole means to the vertices of the primary frame base member, (3) placing the secondary frame roof member on the floor, (4) connecting the secondary elongated vertical pole means to the vertices of the secondary frame roof member, (5) reversing the position of the frame roof member along with the connected secondary elongated vertical pole means, (6) connecting the lower ends of the secondary elongated vertical pole means to the upper ends of primary elongated vertical pole means in a way by inserting the lower ends of the secondary elongated vertical pole means to the upper ends of primary elongated vertical pole means, (7) locking the frame assembly using the levers available on the upper ends of primary elongated vertical pole means, (8) connecting the wall cover panels to each other and leaving at least two ends unconnected to form a single foldable cover panel, (9) placing the central base panel under the primary frame base member on the floor, (10) placing the central roof cover panel on the central roof cover panel and (11) enclosing the tent by connecting the upper ends of the single foldable wall cover panel to the edges of central roof cover panel and connecting the lower ends of single foldable wall cover panel to the edges of central base panel.

In further embodiment, the present invention relates to method of extending the height of grow tent, the method comprising the steps of (1) opening the horizontal closable opening available on the single foldable wall cover panel forming a set of upper wall cover panel and lower wall cover panel, (2) unlocking the frame connection by lifting up levers available on the upper ends of the primary elongated vertical pole means; (3) extending the height of the tent frame assembly by lifting up the secondary elongated vertical pole means until desired height is achieved, (4) locking the connection and frame assembly by pulling down the levers available on the upper ends of the primary elongated vertical pole means; (5) enclosing the space obtained due to height extension by connecting the foldable height adjustment cover panel to the lower ends of the upper cover panel and (6) connecting the foldable height adjustment cover panel to the upper ends of the lower cover panel.

The present invention also relates, in one optional embodiment, to a method of extending the height of grow tent. The method may comprise steps of (1) opening the horizontal closable opening available on the single foldable wall cover panel further exposing a panel which is telescopically hidden inside the single foldable wall cover panel, (2) unlocking the frame connection by lifting up levers available on the upper ends of the primary elongated vertical pole means, (3) extending the height of the tent frame assembly by lifting up the secondary elongated vertical pole means until desired height is achieved and (4) locking the connection and frame assembly by pulling down the levers available on the upper ends of the primary elongated vertical pole means.

In one embodiment of the present invention, the closable openings of the grow tent are closed and opened using any appropriate fastener, such as a zipper, buttons, hook and loop fasteners, a drawstring, and the like.

In another embodiment of the present invention, a Y connector may be used to connect the vertices of the primary frame base member to the lower ends of primary elongated vertical pole means and the vertices of the secondary frame roof member to the upper ends of secondary elongated vertical pole means.

Although embodiments of the invention have been described with reference to the embodiments illustrated in the attached drawing figures, it is noted that equivalents may be employed and substitutions made herein without departing from the scope of the invention as recited in the claims.

having thus described in various embodiments of the invention, what is claimed as new and desired to be protected by Letters Patent includes the following:

1. A tent assembly for growing plants, the tent assembly comprising:
a) a tent frame assembly including:
i. a primary frame base member, wherein the said primary frame base member includes at least six vertices;
ii. at least six primary elongated vertical pole means having an upper and lower end, wherein the said lower ends of the said primary elongated vertical pole means are detachably attachable to the said vertices of the said primary frame base member, wherein the said upper end of the said primary elongated vertical pole means includes a height adjustment means that allows users to adjust the height of the tent;
iii. a secondary frame roof member, wherein the said secondary frame roof member includes at least six vertices; and
iv. at least six secondary elongated vertical pole means having an upper and lower end, wherein the said upper ends of the said secondary elongated vertical pole means are detachably attachable to the said vertices of the said secondary frame roof member, wherein the lower ends of the said secondary elongated vertical pole means are adjustably attachable to the upper ends of said primary elongated vertical pole means;
b) a tent fabric cover assembly including:
i. a central roof cover panel, wherein the said central roof cover panel includes a circular opening;
ii. a central base panel;
iii. at least six wall cover panels that are detachably attachable to each other, detachably attachable to the said central roof cover panel, and to the said central base panel, wherein the said six wall cover panels further includes a detachably attachable horizontal closable opening, wherein the said six wall cover panels includes a front panel, a back panel, a front right side panel, a back right side panel, a front left side panel and a back left side panel, wherein the said front panel further includes a window and a detachably attachable closable opening which acts as a door to enter into the grow tent, wherein the said back right side panel and the back left side panel further includes an upper and lower vents, wherein the said back panel further includes at least two apertures which are diagonally provided at the upper and lower corners of the said back panel; and
iv. at least one foldable height adjustment cover panel, wherein the said foldable height adjustment cover panel further includes attachment means that enables detachable attachment of the said foldable height adjustment cover panel to the horizontal closable opening of the said six wall cover panels and enables users to vertically extend the height of the said tent assembly.

2. A tent assembly for growing plants, the tent assembly comprising:
a) a tent frame assembly including:
i. a primary frame base member, wherein the said primary frame base member includes at least six vertices;
ii. at least six primary elongated vertical pole means having an upper and lower end, wherein the said lower ends of the said primary elongated vertical pole means are detachably attachable to the said vertices of the said primary frame base member, wherein the said upper end of the said primary elongated vertical pole means includes a height adjustment means that allows users to adjust the height of the tent;
iii. a secondary frame roof member, wherein the said secondary frame roof member includes at least six vertices; and
iv. at least six secondary elongated vertical pole means having an upper and lower end, wherein the said upper ends of the said secondary elongated vertical pole means are detachably attachable to the said vertices of the said secondary frame roof member, wherein the lower ends of the said secondary elongated vertical pole means are adjustably attachable to the upper ends of said primary elongated vertical pole means;
b) a tent fabric cover assembly including:
i. a central roof cover panel, wherein the said central roof cover panel includes a circular opening;
ii. a central base panel;
iii. at least six wall cover panels that are detachably attachable to each other, detachably attachable to the said central roof cover panel, and to the said central base panel, wherein the said six wall cover panels further includes a detachably attachable horizontal closable opening that further includes a telescopically hidden panel which is extended exteriorly and enables users to vertically extend the height of the said tent assembly, wherein the said six wall cover panels includes a front panel, a back panel, a front right side panel, a back right side panel, a front left side panel and a back left side panel, wherein the said front panel further includes a window and a detachably attachable closable opening which acts as a door to enter into the grow tent, wherein the said back right side panel and the back left side panel further includes an upper and lower vents, wherein the said back panel further includes at least two apertures which are diagonally provided at the upper and lower corners of the said back panel.

3. The tent assembly of claim 2, wherein the said telescopically hidden panel includes an outer fabric surface and an inner reflective surface, wherein the said inner reflective surface is provided in a hexagonal pattern for better reflection of light to the plants.

4. The tent assembly of claims 1 and 2, wherein the said tent fabric cover includes an outer fabric surface and an inner reflective surface, wherein the said inner reflective surface is provided in a hexagonal pattern for better reflection of light to the plants.

5. The tent assembly of claims 1 and 2, where in the said tent fabric cover is made of a material which is water resistant.

6. A method of assembling grow tent, the method comprising the steps of:
Placing the primary frame base member on the floor;
Connecting the lower ends of the primary elongated vertical pole means to the vertices of the primary frame base member;
Placing the secondary frame roof member on the floor;
Connecting the upper ends of the secondary elongated vertical pole means to the vertices of the secondary frame roof member;
Reversing the position of the frame roof member along with the connected secondary elongated vertical pole means;
Connecting the lower ends of the secondary elongated vertical pole means to the upper ends of primary elongated vertical pole means in a way by inserting the lower ends of the secondary elongated vertical pole means to the upper ends of primary elongated vertical pole means;
Locking the frame assembly using the levers available on the upper ends of primary elongated vertical pole means;
Connecting the wall cover panels to each other and leaving at least two ends unconnected to form a single foldable cover panel;
Placing the central base panel under the primary frame base member on the floor;
Placing the central roof cover panel on the central roof cover panel; and
Enclosing the tent by connecting the upper ends of the single foldable wall cover panel to the edges of central roof cover panel and connecting the lower ends of single foldable wall cover panel to the edges of central base panel.

7. A method of extending the height of grow tent, the method comprising the steps of:
Opening the horizontal closable opening available on the single foldable wall cover panel forming a set of upper wall cover panel and lower wall cover panel;
Unlocking the frame connection by lifting up levers available on the upper ends of the primary elongated vertical pole means;
Extending the height of the tent frame assembly by lifting up the secondary elongated vertical pole means until desired height is achieved;
Locking the connection and frame assembly by pulling down the levers available on the upper ends of the primary elongated vertical pole means;
Enclosing the space obtained due to height extension by connecting the foldable height adjustment cover panel to the lower ends of the upper cover panel; and
Connecting the foldable height adjustment cover panel to the upper ends of the lower cover panel.

8. A method of extending the height of grow tent, the method comprising the steps of:
Opening the horizontal closable opening available on the single foldable wall cover panel further exposing a panel which is telescopically hidden inside the single foldable wall cover panel;
Unlocking the frame connection by lifting up levers available on the upper ends of the primary elongated vertical pole means;
Extending the height of the tent frame assembly by lifting up the secondary elongated vertical pole means until desired height is achieved; and
Locking the connection and frame assembly by pulling down the levers available on the upper ends of the primary elongated vertical pole means.
